(19) United States
(12) Patent Application Publication
(10) Pub. No.: US 2024/0321096 A1
(43) Pub. Date: Sep. 26, 2024

(54) LOCALIZATION USING POSITION COORDINATION OF ROAD SIGNS

(71) Applicant: QUALCOMM Incorporated, San Diego, CA (US)

(72) Inventors: Ali Reza ABBASPOUR, Escondido, CA (US); Rahul GULATI, San Diego, CA (US); Ahmed Kamel SADEK, San Diego, CA (US)

(21) Appl. No.: 18/189,050

(22) Filed: Mar. 23, 2023

(51) Int. Cl. G08G 1/13; B60W 50/14; B60W 60/00; G08G 1/017

(52) U.S. Cl. CPC G08G 1/13; B60W 50/14; B60W 60/0053; G08G 1/017; B60W 2050/143; B60W 2420/403; B60W 2420/408; B60W 2554/4041

(57) ABSTRACT

Systems and methodologies for determining validity of a location of a vehicle include obtaining a first location of the vehicle corresponding to a first time. A first RSU signal including an indication of a location of the first RSU is received at the vehicle from a first Roadside Unit (RSU). One or more location measurements are obtained of the vehicle relative thee first RSU based on one or more sensors of the vehicle. The first location of the vehicle is compared with the first RSU-based location of the vehicle.

### BACKGROUND

An autonomous vehicle often requires accurate information about its current location as it moves along streets or other terrain. This may advantageously allow the vehicle to generate and follow a correct path and/or speed.

To accomplish this, a vehicle may receive and utilize Global Positioning System (GPS) signals to determine a current position of the vehicle, and in turn use that current position information as input for navigation applications. GPS is an example of a Global Navigation Satellite System (GNSS) navigation system in which a receiver determines a position of the receiver by precisely measuring the arrival time of signaling events received from multiple satellites. However, GPS signals are not always reliably received by the receiver. For example, GPS accuracy may degrade significantly under weak signal conditions such as when the line-of-sight (LOS) to the satellite(S) is obstructed by natural or manmade objects, such as tall buildings, mountains or canyons. Depending on the environment, the receiver (e.g., in a vehicle) may not even receive the GPS signal, or the accuracy of the GPS may result in positional errors on the order of tens of meters (e.g., as much as 50 meters). Furthermore, the GPS signal is susceptible to spoofing by a hacker or intruder.

Another navigational system that may be employed by a vehicle determines distance traveled and the heading of the vehicle using Inertial Measurement Unit (IMU) sensors employed on the vehicle, which are then processed to calculate a position of the vehicle. If one or more Inertial Measurement Unit (IMU) sensor measurements are inaccurate, then the error induced by this lack of accuracy, over long stretches of time, may result in significant error in the determined distance travelled, and/or a bias in the determined heading of the vehicle.

Additionally, having an updated map is crucial for autonomous driving safety. For example, a construction zone sign may be added to a road, and not regulating vehicle speeds based on the new situation may increase the risk of accidents, e.g., with construction workers.

Due to the increasing demands of the automotive industry, future consumer navigational systems will require higher location accuracy than that of currently employed systems. Path planning, path following, and speed profile without an updated, accurate and resilient localization could cause hazards and fatal accidents for passengers and other road users.

### SUMMARY

A method of determining validity of a location of a vehicle according to the disclosure includes obtaining, for example, a first location of the vehicle corresponding to a first time. A first Roadside Unit (RSU) signal including an indication of a location of the first RSU is received at the vehicle from a first RSU. One or more location measurements of the vehicle relative the first RSU is obtained based on one or more sensors of the vehicle. A first RSU-based location of the vehicle corresponding to the first time is determined based, at least in part, on the one or more location measurements of the vehicle relative the first RSU, and the location of the first RSU. The first location of the vehicle is compared with the first RSU-based location of the vehicle.

An example system for determining validity of a location of a vehicle according to the disclosure includes a memory, and at least one processor communicatively coupled to the memory. At least one processor is configured to: obtain a first location of the vehicle corresponding to a first time; receive, at the vehicle from a first Roadside Unit (RSU), a first RSU signal including an indication of a location of the first RSU; obtain one or more location measurements of the vehicle relative the first RSU based on one or more sensors of the vehicle; determine a first RSU-based location of the vehicle corresponding to the first time based, at least in part, on the one or more location measurements of the vehicle relative the first RSU, and the location of the first RSU; and compare the first location of the vehicle with the first RSU-based location of the vehicle.

An example system for determining validity of location of a vehicle according to the disclosure includes: means for obtaining a first location of the vehicle corresponding to a first time; means for receiving, at the vehicle from a first Roadside Unit (RSU), a first RSU signal including an indication of a location of the first RSU; means for obtaining one or more location measurements of the vehicle relative the first RSU based on one or more sensors of the vehicle; means for determining a first RSU-based location of the vehicle corresponding to the first time based, at least in part, on the one or more location measurements of the vehicle relative the first RSU, and the location of the first RSU; and means for comparing the first location of the vehicle with the first RSU-based location of the vehicle.

An example non-transitory processor-readable storage medium according to the disclosure includes processor-readable instructions configured to cause one or more processors to determine validity of location of a vehicle. The non-transitory processor-readable storage medium may include: code for obtaining a first location of the vehicle corresponding to a first time; code for receiving at the vehicle from a first Roadside Unit a first RSU signal including an indication of a location of the first RSU; code for obtaining one or more location measurements of the vehicle relative the first RSU based on one or more sensors of the vehicle; and code for comparing the first location of the vehicle with the first RSU-based location of the vehicle.

### BRIEF DESCRIPTION OF THE DRAWINGS

Non-limiting and non-exhaustive aspects are described with reference to the following figures.

FIG. 1 illustrates a block diagram of example components and/or systems implemented in a vehicle.

FIG. 2 illustrates a view of an example vehicle configured with various sensor and communications components and/or systems.

FIG. 3 is a functional block level diagram of an example vehicle.

FIG. 4 illustrates an example vehicle that is travelling on a road with Roadside Units (RSUs) positioned at various intervals.

FIG. 5 shows an example method of determining validity of a location of a vehicle.

FIG. 6 is an example flow diagram of vehicle action based on validity of a location of the vehicle.

### DETAILED DESCRIPTION

Techniques for determining a validity of a location of a vehicle are provided. Advantageously, roadside units (RSUs) positioned at various intervals along a road provide respective indications of locations of the RSUs to vehicles near the RSUs. A vehicle may compare a location of the vehicle determined with, for example, GPS Global Positioning Satellite (GPS) signals and/or Inertial Measurement Unit (IMU) measurement, with a vehicle location determined based on one or more of the RSU locations, and one or more distances from one or more of the RSUs. These techniques and configurations are examples, and other configurations and techniques may be used.

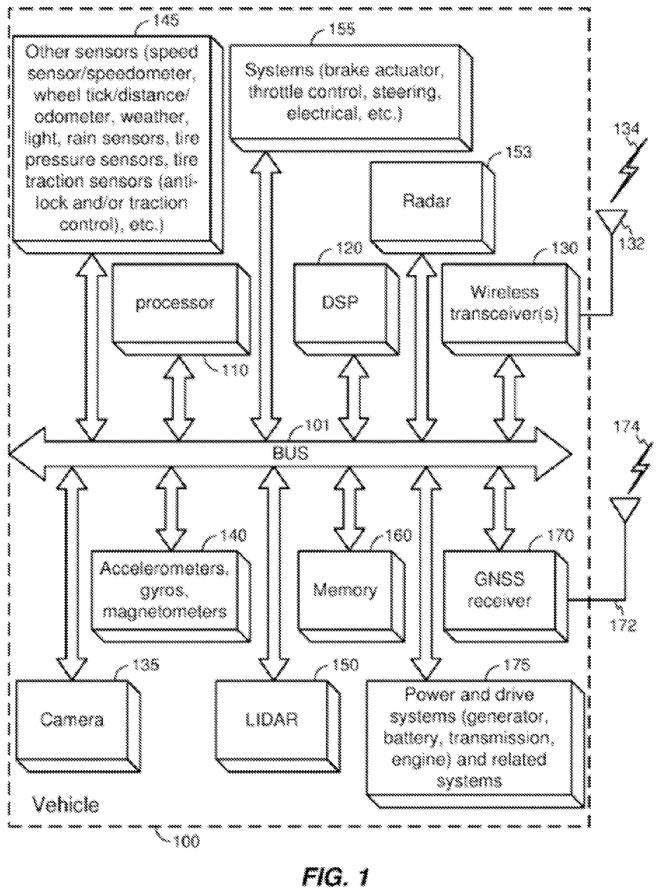

FIG. 1 is a block diagram of various components and/or systems implemented in an example vehicle, such as a car. The vehicle 100 may be non-autonomous, autonomous, or semi-autonomous. The vehicle 100 may include a camera 135 (which may include one or more cameras). The camera 135 may comprise a camera sensor and mounting assembly. Different mounting assemblies may be used for different cameras on the vehicle 100. For example, front facing cameras may be mounted in a front bumper, in a stem of a rear-view mirror assembly and/or in other front facing areas of the vehicle 100. Rear facing cameras may be mounted in a rear bumper/fender, on a rear window, and/or on a trunk or other rear facing areas of the vehicle 100. Side facing mirrors may be mounted on sides of the vehicle 100 such as being integrated into mirror assemblies and/or door assemblies. The cameras 135 may facilitate object detection and distance estimation, particularly for objects of known size and/or shape (e.g., a stop sign and a license plate both have standardized size and shape) and may also provide information regarding rotational motion relative to an axis of the vehicle 100 such as during a turn. The cameras 135 may be used in concert with other sensors, such as LIDAR, wheel tick/distance sensors, and/or GNSS to verify distance traveled and angular orientation. The camera 135 may be used to verify and calibrate one or more other systems to verify that distance measurements are correct, for example by calibrating against known distances between known objects (landmarks, roadside markers, road mile markers, etc.), and/or to verify that object detection is performed accurately such that objects are accordingly mapped to the correct locations relative to the car by LIDAR and other systems. Camera data may be combined with, for example, accelerometer data such that impact time with road hazards may be estimated (elapsed time before hitting a pot hole for example) which may be verified against actual time of impact and/or verified against stopping models (for example, compared against the estimated stopping distance if attempting to stop before hitting an object) and/or maneuvering models (verifying whether current estimates for turning radius at current speed and/or a measure of maneuverability at current speed are accurate in the current conditions and modifying accordingly to update estimated parameters based on camera and other sensor measurements).

Accelerometers, gyros and magnetometers 140 may be utilized to provide and/or verify motion and directional information. For example, accelerometers and gyros may be utilized to monitor wheel and drive train performance. Accelerometers may also be utilized to verify actual time of impact with road hazards such as potholes relative to predicted times based on existing stopping and acceleration models as well as steering models. Gyros and magnetometers may, in an embodiment, be utilized to measure rotational status of the vehicle as well as orientation relative to magnetic north, respectively. Gyros and magnetometers may also be used to measure and calibrate estimates and/or models for turning radius at current speed and/or a measure of maneuverability at current speed, particularly when used in concert with measurements from other external and internal sensors 145 such as such as speed sensors, wheel tick sensors, and/or odometer measurements.

The light detection and ranging (LIDAR) 150 subsystem uses pulsed laser light to measure ranges to objects. While cameras may be used for object detection, LIDAR 150 provides a means, to detect the distances (and orientations) of the objects with more certainty, especially in regard to objects of unknown size and shape. LIDAR 150 measurements may also be used to estimate rate of travel, vector directions, relative position and stopping distance by providing accurate distance measurements and delta distance measurements.

Memory 160 may be utilized with processor 110 and/or DSP 120. The memory 160 may comprise FLASH, RAM, ROM, disc drive, or FLASH card or other memory devices or various combinations thereof. In an embodiment, memory 160 may contain instructions to implement various methods described throughout this description including, for example, processes to implement the use of relative positioning between vehicles and between vehicles and external reference objects such as roadside units. In an embodiment, memory 160 may contain instructions for operating and calibrating sensors, and for receiving map, weather, vehicular (both vehicle 100 and surrounding vehicles) and other data. Memory 160 may also contain instructions for utilizing various internal and external sensor measurements, and received data and measurements, to determine driving parameters such as relative position, absolute position, stopping distance, acceleration and turning radius at current speed and/or maneuverability at current speed, inter-car distance, turn initiation/timing and performance, and initiation/timing of driving operations.

Power and drive systems (generator, battery, transmission, engine) and related systems 175, and systems (brake, actuator, throttle control, steering, and electrical) 155, may be controlled by the processor(s), hardware, software and/or by an operator of the vehicle or by some combination thereof. The systems (brake, actuator, throttle control, steering, electrical, etc.) 155, and power and drive or other systems 175, may be utilized in conjunction with performance parameters and operational parameters, to enable autonomously (and manually, relative to alerts and emergency overrides/braking/stopping) driving and operating a vehicle 100 safely and accurately (e.g., with regard to merging into traffic, stopping, accelerating and otherwise operating the vehicle 100). Input from the various sensor systems such as camera 135, accelerometers, gyros and magnetometers 140, LIDAR 150, GNSS receiver 170, RADAR 153, and/or input, messaging and/or measurements from wireless transceiver(s) 130 and/or other sensors 145 or various combinations thereof, may be utilized by processor 110 and/or DSP 120 or other processing systems to control power and drive systems 175 and systems 155 (e.g., brake actuator, throttle control, steering, electrical, etc.).

A global navigation satellite system (GNSS) receiver may be utilized to determine position relative to the earth (absolute position) and, when used with other information such as measurements from other objects and/or mapping data, to determine position relative to other objects such as relative to other cars and/or relative to the road surface.

GNSS receiver 170 may support one or more GNSS constellations as well as other satellite-based navigation systems. For example, GNSS receiver 170 may support global navigation satellite systems such as the Global Positioning System (GPS), the Global'naya Navigatsionnaya Sputnikovaya Sistema (GLONASS), Galileo, and/or BeiDou, or any combination thereof. In an embodiment, GNSS receiver 170 may support regional navigation satellite systems such as NAVIC or QZSS or combination thereof, as well as various augmentation systems (e.g., satellite based augmentation systems (SBAS) or ground based augmentation systems (GBAS)), such as doppler orbitography, radio-positioning integrated by satellite (DORIS), wide area augmentation system (WAAS), the European geostationary navigation overlay service (EGNOS), the multi-functional satellite augmentation system (MSAS) or the local area augmentation system (LAAS). In an embodiment, GNSS receiver(s) 130 and antenna(s) 132 may support multiple bands and sub-bands such as GPS L1, L2 and L5 bands, Galileo E1, E5, and E6 bands, Compass (BeiDou) B1, B3 and B2 bands, GLONASS G1, G2 and G3 bands, and QZSS LIC, L2C and L5-Q bands.

The GNSS receiver 170 may be used to determine location and relative location, which may be utilized for location, navigation, and to calibrate other sensors, when appropriate. For example, the GNSS receiver 170 may be used to determine distance between two time points in clear sky conditions and using the distance data to calibrate other sensors such as the odometer and/or LIDAR. In an embodiment, GNSS-based relative locations, based on, for example, shared doppler and/or pseudorange measurements between vehicles, may be used to determine highly accurate distances between two vehicles. These distances can be combined with vehicle information such as shape and model information, and GNSS antenna location, to calibrate, validate and/or affect the confidence level associated with information from LIDAR, camera, RADAR, SONAR and other distance estimation techniques. GNSS doppler measurements may also be utilized to determine linear motion and rotational motion of the vehicle or of the vehicle relative to another vehicle, which may be further utilized in conjunction with gyro and/or magnetometer and other sensor systems to maintain calibration of those systems based upon measured location data. Relative GNSS positional data may also be combined with high confidence absolute locations from roadside devices, also known as roadside units or RSU, to determine high confidence absolute locations of the vehicle. Furthermore, relative GNSS positional data may be used during inclement weather, which may obscure LIDAR and/or camera-based data sources, to avoid other vehicles and to stay in the lane or other allocated road arca. For example, using an RSU equipped with GNSS receiver and V2X capability, GNSS measurement data may be provided to the vehicle, which, if provided with an absolute location of the RSU, may be used to navigate the vehicle relative to a map, keeping the vehicle in lane and/or on the road, in spite of lack of visibility.

Radio detection and ranging-radar 153, uses transmitted radio waves that are reflected off of objects. The reflected radio waves are analyzed, based on the time taken for reflections to arrive and other signal characteristics of the reflected waves, to determine location of nearby objects. Radar 153 may be utilized to detect the location of nearby cars, roadside objects (signs, other vehicles, pedestrians, etc.) and will generally enable detection of objects even if there is obscuring weather such as snow, rail or hail. Thus, radar 153 may be used to complement LIDAR 150 systems and camera 135 systems in providing ranging information to other objects by providing ranging and distance measurements and information when visual-based systems typically fail. Furthermore, radar 153 may be utilized to calibrate and/or perform a sanity check other systems such as LIDAR 150 and camera 135. Ranging measurements from radar 153 may be utilized to determine/measure stopping distance at current speed, acceleration, maneuverability at current speed, and/or turning radius at current speed. In some systems, ground penetrating radar may also be used to track road surfaces via, for example, RADAR-reflective markers on the road surface or terrain features such as ditches.

The vehicle 100 may further contain multiple wireless transceivers including radio, WAN, WLAN and/or PAN transceivers. In an embodiment, the vehicle may include radio technologies that may support a wireless communication link or links, which may further comprise a Wireless local area network (e.g., WLAN, e.g., IEEE 802.11), Bluetooth (BT) and/or ZigBcc.

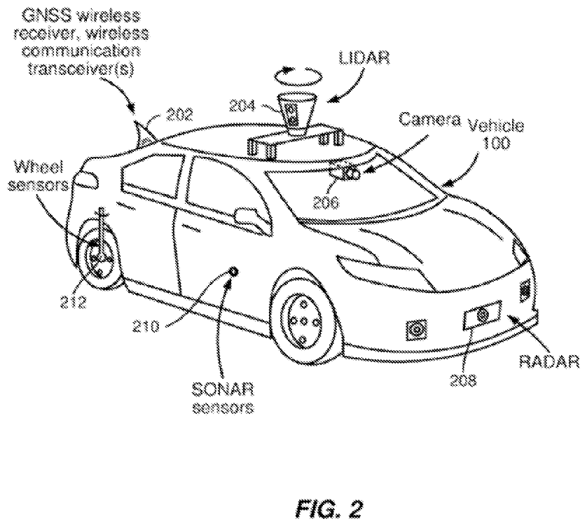

FIG. 2 illustrates a view of a vehicle configured with example sensor and communications components and/or systems. As shown in FIG. 2, the vehicle 100 may have, for example, camera(s) such as rear view mirror-mounted camera 206, front fender-mounted camera (not shown), side mirror-mounted camera (not shown) and a rear camera (not shown, but typically on the trunk, hatch or rear bumper). Vehicle 100 may also have a LIDAR subsystem 204, for detecting objects and measuring distances to those objects; LIDAR SYSTEM 204 is often roof-mounted, however, if there are multiple LIDAR units 204, they may be oriented around the front, rear and sides of the vehicle. Vehicle 100 may have other various location-related systems such as the GNSS receiver 170 (typically located in a shark fin 202 on the rear of the roof), various wireless transceivers (such as radio, WAN, WLAN, V2X; typically but not necessarily located in the shark fin 202), RADAR system 208 (typically in the front bumper), and SONAR 210 (typically located on both sides of the vehicle, if present). Various wheel sensors 212 and drive train sensors may also be present, such as tire pressure sensors, accelerometers, gyros, and wheel rotation detection and/or counters. This list is not limiting and FIG. 2 provides example locations of various sensors, but other configurations of a vehicle may be used. In addition, further detail in regard to particular sensors is described relative to FIG. 1.

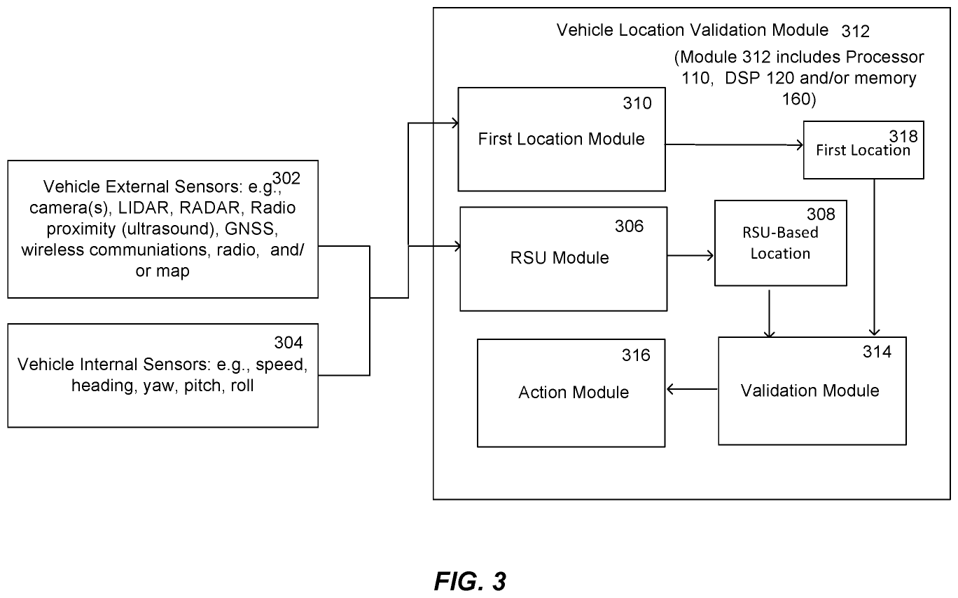

Referring also to FIG. 3, a functional block level diagram of the vehicle 100 includes the functional blocks shown for determining validity of a location of the vehicle 100. Illustratively, a Vehicle Location Validation module 312 may include one or more processors executing code, and may further include additional modules, such as, without limitation, a First Location Module 310, an RSU module 306, a Validation Module 314 and an Action Module 316. The Vehicle Location Validation Module 312 receives information from, without limitation, vehicle external sensors 302 and vehicle internal sensors 304. The received vehicle sensor output, which may be used to provide, without limitation, GPS and/or IMU location information, is used by the First Location Module 310 to obtain a first location 318 of the vehicle 100. The Roadside Unit (RSU) Module 306 receives an RSU signal (from the external sensors 302, e.g., via radio transmission) from an RSU (described in more detail below) that the vehicle 100 encounters. The RSU signal includes an indication of a location of the RSU. The RSU module 306 further obtains a distance between the vehicle 100 and the RSU based on signals received from the external sensors 302 (e.g., via radar, or radio localization if there is no direct line of sight). Using the indication of the location received from the RSU and the distance between the vehicle 100 and RSU, an RSU-based location 308 of the vehicle 100 is determined by the RSU module 306. The Validation module 314 compares the first location 318 and the RSU-based location 308 to validate whether the first location 318 is correct (e.g., within an acceptable error margin of the RSU-based location 308). The Action module 316 may take one or more of several actions (described in more detail below) based on the comparison of the first location 318 and the RSU-based location 308.

The vehicle external sensors 302 may include, without limitation, the camera 206, the LIDAR system 204, the radar system 208, a radio transmission system, one or more proximity sensors, one or more rain sensors, one or more weather sensors, the GNSS receiver 170 wireless communications and/or radio (see also FIGS. 1 and 2, and accompanying text). The vehicle internal sensors 304 may include: wheel sensors 212 such as tire pressure sensors, brake pad sensors, brake status sensors, speedometers and other speed sensors; heading sensors and/or orientation sensors such as magnetometers and geomagnetic compasses; distance sensors such as odometers and wheel tick sensors; and/or inertial sensors such as accelerometers and gyros.

The vehicle internal sensors 304 and/or the vehicle external sensors 302 may have shared or dedicated processing capability. For example, a sensor system or subsystem may have a sensor processing core or cores that determines one or more car status values based on measurements and/or other inputs from one or more accelerometers, one or more gyros, one or more magnetometers and/or one or more other sensing systems. The car status values may include yaw, pitch, roll, heading, speed, acceleration capability and/or distance, and/or stopping distance. The different sensing systems may communicate with each other to determine measurement values. The car status value(s) derived from measurements from the internal and external sensors 302, 304 may be further combined with car status values and/or measurements from one or more other sensor systems using a general processor and/or an applications processor. The sensors may be segregated into related systems, for example, LIDAR, radar, motion, wheel systems.

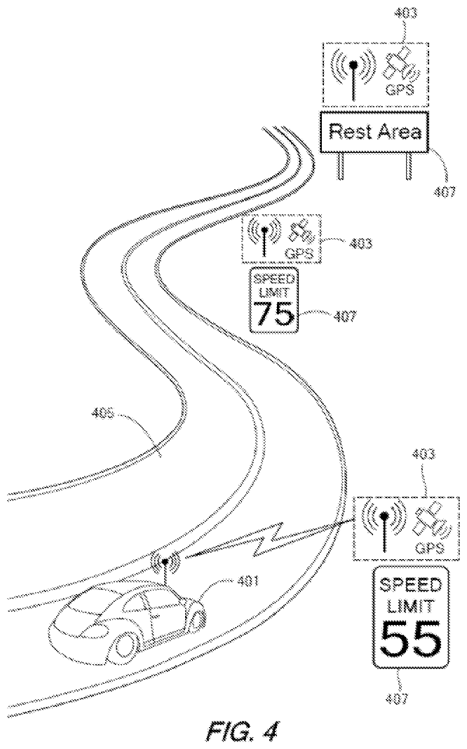

FIG. 4 illustrates a vehicle 401 that is travelling on a road 405 with Roadside Units (RSUs) 403 positioned at various locations. The RSUs 403 may be provided at specific intervals along the road 405, or may be non-periodically placed in a more random pattern. Each of the RSUs 403 may be, without limitation, part of, or attached to a respective object such as a sign 407, building, tree or other natural object, bridge, overpass, or telephone post, etc., or may be a standalone unit. Each RSU 403 is configured to provide an indication of a location of the RSU and/or an indication of an RSU type (e.g., a speed limit sign). An RSU 403 may include a transmitter module that can send a unique identification number. e.g., in a broadcast signal that may be received by receivers, e.g., in vehicles, in a vicinity of the RSU 403. A vehicle 401 receiving the identification number of a particular RSU 403 may look up the received identification number in a table or map data to retrieve the location of the RSU 403, which may be, without limitation, one or more coordinates (e.g., latitude and longitude). The RSU 403 may also expressly send the location (e.g. a set of position coordinates) of the RSU 403 directly to the vehicle 401.

In addition to sending an indication of its location to the vehicle 401, the RSU 403 may also send other information. This other information may include RSU type (e.g. a speed limit sign) and/or various warnings. For example, an RSU 403 may indicate that road hazards or bad weather conditions are ahead (such as road construction, icy roads or an accident) and/or provide a recommended speed. The RSU 403 may have a communications interface, such that, without limitation, road or weather conditions can be received, which may then be communicated to the vehicle 401. The RSU 403 may be configured to receive information from another RSU 403, e.g., a transmission from one or more other RSUs 403 along the road 405, such that advance warning can be provided to a vehicle 401 travelling on the road 405. The RSU 403 may include a camera or other sensors to determine road conditions, which may then be communicated to the vehicle 401. The RSU may have some level of processing power/intelligence to, without limitation, aid in determine surrounding conditions, which may then be communicated to the vehicle.

An RSU 403 may be powered by, without limitation, a battery, solar and/or wind power. The RSU 403 may be connected to a transmission line that provides power to the RSU 403.

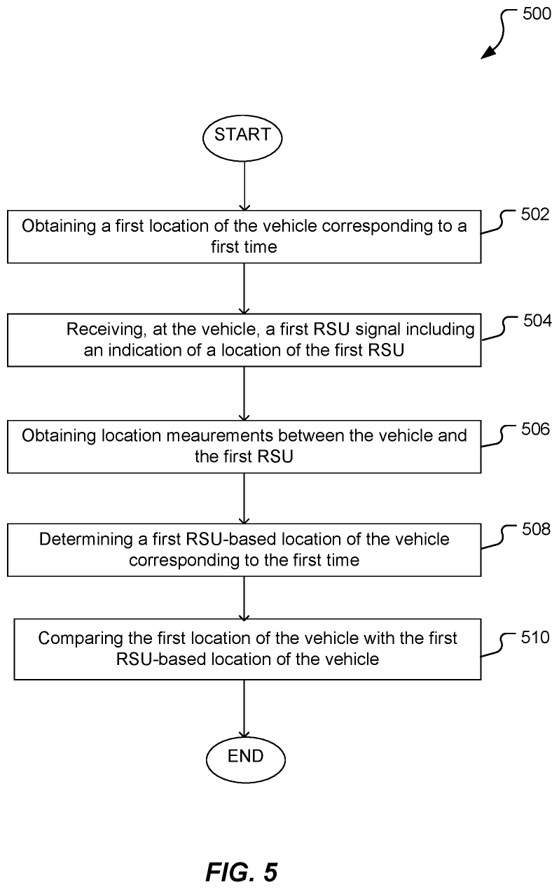

Referring to FIG. 5, with further reference to FIGS. 1-4, an example method 500 of determining validity of a location of a vehicle is shown. The method 500 is, however, an example and not limiting. The method 500 may be altered, e.g., by having one or more single stages split into multiple stages, multiple stages combined into a single stage, multiple stages performed concurrently, etc.

At stage 502, a first location of the vehicle is obtained corresponding to a first time. In an example, the external sensors 302 and internal sensors 304, including without limitation GNSS receiver 170, accelerometers, gyros, magnetometers 140, and other sensors 145, along with the vehicle Location Validation Module 312, and particularly, the First Location Module 310, including without limitation processor 110 and memory 160, may be a means for obtaining the first location 318. For example, the first location may be, without limitation, provided by utilizing GPS/GNSS, or may be based, at least partially, on dead reckoning. Using Dead Reckoning (DR), a current position is calculated based on a previously obtained location and one or more sensor measurements between a time corresponding to the previously obtained position and a present time. Generally, the dead reckoning location of the vehicle at the present time may be determined by advancing the previously obtained location based on sensor information providing, without limitation, heading and speed, as known in the art. For example, the vehicle 100 may be equipped with the sensors 145 and corresponding vehicle information (e.g., dimensions), such as wheel circumference measurements, and may be configured to record wheel rotations and steering direction. Other sensors such as one or more inertial sensors (e.g., accelerometer, gyroscope, solid state compass) may also be used.

At stage 504, the method 500 includes receiving, at the vehicle from a first Roadside Unit (RSU), a first RSU signal including an indication of a location of the first RSU and/or RSU type. In an example, the external sensors 302 including wireless communication transceivers 202, such as a radio transceiver, along with the Vehicle Location Validation Module 312, and particularly, the RSU Module 306, including without limitation processor 110 and memory 160, may be a means for receiving the first RSU signal.

As described above with regard to FIG. 4, each RSU 403 may be configured to provide an indication of a location of the respective RSU 403. Illustratively, an RSU 403 may include a transmitter module that can send a unique identification number to vehicles in a vicinity of the RSU 403. A vehicle 401 receiving the identification number of a particular RSU 403 may look up the received identification number in a table or map data to retrieve the location of the RSU 403, which may be, without limitation, one or more position coordinates. The RSU 403 may also expressly send the location of the RSU 403 directly to the vehicle 401.

Where the RSU signal includes an identification number, a determination of whether the identification number is registered in a map and/or database may be performed. If it is determined that the RSU is registered in the map and/or database, the RSU may be utilized and the method 500 may continue. Alternatively, if the RSU does not have a registered identification number, the vehicle 100 may not utilize the RSU and instead, the RSU identification number, location indication and type (for example, school sign) may be reported by the vehicle 100 to a server (e.g., in the cloud) for registration and/or future addition to the map and/or database. In various examples, the observed RSU(s) that was(were) not registered/recorded in the map may be identified and sent to the cloud and if the same RSU(s) is(are) reported by multiple (e.g., a threshold number of) vehicles, the reported RSU(s) may be registered by the server and added to the map and/or database whereupon the RSU(s) can then be utilized, e.g., to help determine a location of the vehicle 100 and/or another vehicle. Illustratively, if the RSU is reported by more than N cars, then the RSU may be registered and the map and/or database updated with the new RSU. For example, if more than two vehicles in a row report an RSU, then the RSU may be registered and the map and/or database updated so that vehicles could start utilizing this RSU. Increasing N (the number of reports of the same RSU) will increase the confidence in the detection of a valid RSU, and reduce the false positive rate.

At stage 506, one or more location measurements are obtained of the vehicle relative to the first RSU. The location measurements may include, without limitation, a distance and/or a bearing between the vehicle and the first RSU. In an example, the external sensors 302 including, without limitation, a radio transceiver, camera, lidar and/or radar, along with the Vehicle Location Validation Module 312 (e.g., the RSU Module 306, including without limitation the processor 110 and the memory 160), may be a means for obtaining the location measurements.

Illustratively, if the vehicle 100 has a line of sight to the first RSU, the vehicle 100 can measure/determine the distance and/or bearing to the first RSU using various sensors, such as camera, radar, and/or lidar sensors. For example, a vision/optical sensor(s) (e.g., the camera 135) may be configured to obtain one or more images that includes the first RSU. One or more recognition processes may be performed on the obtained image(s) to identify the first RSU. The recognition process(es) may take into account the type of RSU (e.g., the RSU is a sign, on a bridge etc.). Using a radar or LIDAR system (or other sensor), a distance and/or bearing to the first RSU from the vehicle 100 may be determined.

If the vehicle receives the signal but cannot see the RSU (e.g., the line of sight to the sign is occluded, e.g., by other vehicles), then the vehicle 100 may still obtain approximate location measurements through a radio-localization approach. In this approach, in a non-line-of-sight (NLOS) condition, location measurements of the vehicle to the RSU may be determined based on received signal strength indicator (RSSI) measurements. RSSI measurements may be used even under an LOS condition.

At stage 508, a first RSU-based location of the vehicle corresponding to the first time is determined. For example, a first RSU-based location of the vehicle may be determined based on the one or more location measurements determined at stage 506, and the indication of a location of the first RSU, received at stage 504. In an example, the Vehicle Location Validation Module 312, and particularly the RSU Module 306, including without limitation, the processor 110 and the memory 160, may be a means for determining the first RSU-based location 308 of the vehicle.

At stage 510, the first location of the vehicle is compared with the first RSU-based location of the vehicle. In an example, the Vehicle Location Validation Module 312, and particularly the Validation Module 314, including without limitation the processor 110 and the memory 160, may be a means for comparing the first location of the vehicle with the first RSU-based location of the vehicle. In general, and without limitation, if the first location of the vehicle matches (e.g., is within a threshold difference of, e.g., threshold distance of) the first RSU-based location of the vehicle, the first location is validated and may continue to be utilized by the vehicle. The first location of the vehicle may continue to be utilized by the vehicle if there is a certain threshold confidence level in the first location (e.g., a threshold confidence level that, for example, GPS and/or dead reckoning measurements are correct), regardless of the results of the comparison.

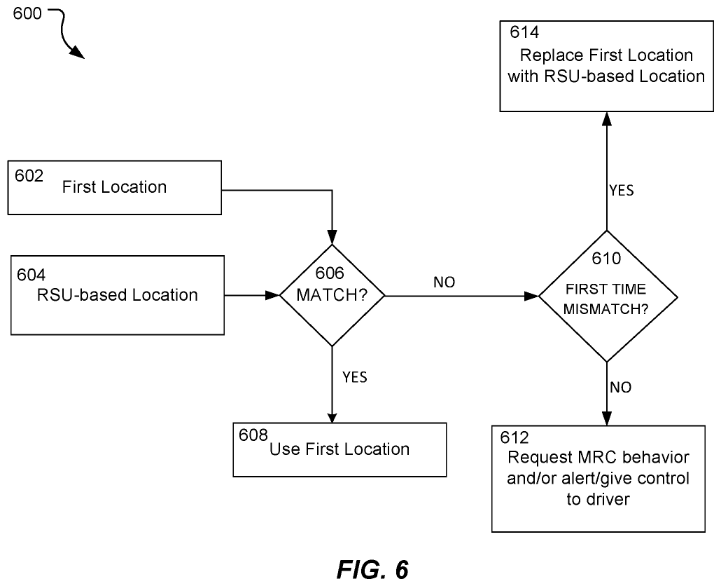

Referring also to FIG. 6, an example method 600 of vehicle action based on a comparison of RSU-based vehicle location and non-RSU-based vehicle location includes the stages shown. At stage 606, a comparison is made of a first location 602 (e.g., the first location 318) and a first RSU-based location 604 (e.g., the RSU-based location 308). If the first location 602 and the first RSU-based location 604 match, e.g., within an acceptable error margin of each other 608, then no change is made to the first location 602, and the first location 602 continues to be utilized as the vehicle location.

However, if the comparison at stage 606 is outside the acceptable error margin, then an inquiry is made at stage 610 as to whether this was the first mismatch determined. For example, if the processor 110 determines that this was the first mismatch of the first location 602 and the RSU-based location 604, then the method 600 proceeds to stage 614 at which the first location 604 may be replaced with the RSU-based location. If the processor determines at stage 610 that the mismatch determined at stage 606 was not the first mismatch (e.g., was a second consecutive mismatch), then the method 600 proceeds to stage 612 at which the processor 110 may request, for example, a Minimal Risk Condition (MRC) behavior (e.g., to park the vehicle 100 outside of an active driving lane), and/or may take other action such as alerting a driver and/or giving control to the driver (if there is a driver behind the steering wheel).

More particularly, after a first mismatch, a vehicle may proceed travelling, and a second location of the vehicle corresponding to a second time may be obtained based on, without limitation, GPS and/or dead reckoning. Similar to determining the validity of the first location, as described above, a second RSU signal including an indication of a location of the second RSU may be received at the vehicle from a second Roadside Unit (RSU), the second RSU signal including an indication of a location of the second RSU. One or more location measurements between the vehicle and the second RSU determined by one or more sensors of the vehicle may be obtained. A second RSU-based location of the vehicle corresponding to the second time may be determined based, at least in part, on the one or more location measurements between the vehicle and the second RSU, and the location of the second RSU. The second location of the vehicle may be compared with the second RSU-based location of the vehicle to validate the second location, whereupon a second mismatch may occur.

A Minimal Risk Condition (MRC) maneuver is an action that a user or an Automated Driving System (ADS) may execute in order to reduce the risk of a crash that may occur without execution of the MRC maneuver (e.g., continuing the vehicle driving status quo). The method 600 is an example, and other examples may be implemented, e.g., with other vehicle action based on the comparison at stage 606 and the inquiry at stage 610. For example, an MRC behavior can be initiated after the first mismatch, or may only be initiated after multiple mismatches, or not at all if there is still a level of confidence in the first location (e.g., based on GPS and/or dead reckoning).

Other examples and implementations are within the scope of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

As used herein, the singular forms “a,” “an,” and “the” include the plural forms as well, unless the context clearly indicates otherwise. The terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Also, as used herein, “or” as used in a list of items (possibly prefaced by “at least one of” or prefaced by “one or more of”) indicates a disjunctive list such that, for example, a list of “at least one of A, B, or C,” or a list of “one or more of A, B, or C” or a list of “A or B or C” means A, or B, or C, or AB (A and B), or AC (A and C), or BC (B and C), or ABC (i.e., A and B and C), or combinations with more than one feature (e.g., AA. AAB, ABBC, etc.). Thus, a recitation that an item, e.g., a processor, is configured to perform a function regarding at least one of A or B, or a recitation that an item is configured to perform a function A or a function B, means that the item may be configured to perform the function regarding A, or may be configured to perform the function regarding B, or may be configured to perform the function regarding A and B. For example, a phrase of “a processor configured to measure at least one of A or B” or “a processor configured to measure A or measure B” means that the processor may be configured to measure A (and may or may not be configured to measure B), or may be configured to measure B (and may or may not be configured to measure A), or may be configured to measure A and measure B (and may be configured to select which, or both, of A and B to measure). Similarly, a recitation of a means for measuring at least one of A or B includes means for measuring A (which may or may not be able to measure B), or means for measuring B (and may or may not be configured to measure A), or means for measuring A and B (which may be able to select which, or both, of A and B to measure). As another example, a recitation that an item, e.g., a processor, is configured to at least one of perform function X or perform function Y means that the item may be configured to perform the function X, or may be configured to perform the function Y, or may be configured to perform the function X and to perform the function Y. For example, a phrase of “a processor configured to at least one of measure X or measure Y” means that the processor may be configured to measure X (and may or may not be configured to measure Y), or may be configured to measure Y (and may or may not be configured to measure X), or may be configured to measure X and to measure Y (and may be configured to select which, or both, of X and Y to measure).

As used herein, unless otherwise stated, a statement that a function or operation is “based on” an item or condition means that the function or operation is based on the stated item or condition and may be based on one or more items and/or conditions in addition to the stated item or condition.

Substantial variations may be made in accordance with specific requirements. For example, customized hardware might also be used, and/or particular elements might be implemented in hardware, software (including portable software, such as applets, etc.) executed by a processor, or both. Further, connection to other computing devices such as network input/output devices may be employed. Components, functional or otherwise, shown in the figures and/or discussed herein as being connected or communicating with each other are communicatively coupled unless otherwise noted. That is, they may be directly or indirectly connected to enable communication between them.

The systems and devices discussed above are examples. Various configurations may omit, substitute, or add various procedures or components as appropriate. For instance, features described with respect to certain configurations may be combined in various other configurations. Different aspects and elements of the configurations may be combined in a similar manner. Also, technology evolves and, thus, many of the elements are examples and do not limit the scope of the disclosure or claims.

A wireless communication system is one in which communications are conveyed wirelessly, i.e., by electromagnetic and/or acoustic waves propagating through atmospheric space rather than through a wire or other physical connection, between wireless communication devices. A wireless communication system (also called a wireless communications system, a wireless communication network, or a wireless communications network) may not have all communications transmitted wirelessly, but is configured to have at least some communications transmitted wirelessly. Further, the term “wireless communication device,” or similar term, does not require that the functionality of the device is exclusively, or even primarily, for communication, or that communication using the wireless communication device is exclusively, or even primarily, wireless, or that the device be a mobile device, but indicates that the device includes wireless communication capability (one-way or two-way), e.g., includes at least one radio (each radio being part of a transmitter, receiver, or transceiver) for wireless communication.

Specific details are given in the description herein to provide a thorough understanding of example configurations (including implementations). However, configurations may be practiced without these specific details. For example, well-known circuits, processes, algorithms, structures, and techniques have been shown without unnecessary detail in order to avoid obscuring the configurations. The description herein provides example configurations, and does not limit the scope, applicability, or configurations of the claims. Rather, the preceding description of the configurations provides a description for implementing described techniques. Various changes may be made in the function and arrangement of elements.

The terms “processor-readable medium,” “machine-readable medium,” and “computer-readable medium,” as used herein, refer to any medium that participates in providing data that causes a machine to operate in a specific fashion. Using a computing platform, various processor-readable media might be involved in providing instructions/code to processor(s) for execution and/or might be used to store and/or carry such instructions/code (e.g., as signals). In many implementations, a processor-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Having described several example configurations, various modifications, alternative constructions, and equivalents may be used. For example, the above elements may be components of a larger system, wherein other rules may take precedence over or otherwise modify the application of the disclosure. Also, a number of operations may be undertaken before, during, or after the above elements are considered. Accordingly, the above description does not bound the scope of the claims.

Implementation examples are described in the following numbered clauses:

Clause 1. A method of determining validity of a location of a vehicle, the method comprising: obtaining a first location of the vehicle corresponding to a first time; receiving, at the vehicle from a first Roadside Unit (RSU), a first RSU signal including an indication of a location of the first RSU; obtaining one or more location measurements of the vehicle relative the first RSU based on one or more sensors of the vehicle; determining a first RSU-based location of the vehicle corresponding to the first time based, at least in part, on the one or more location measurements of the vehicle relative the first RSU, and the location of the first RSU; and comparing the first location of the vehicle with the first RSU-based location of the vehicle.

Clause 2. The method according to clause 1, further comprising: using the first location of the vehicle based on the first RSU-based location of the vehicle being within an acceptable error margin of the first location.

Clause 3. The method according to clause 2, wherein the first location is based on one or more satellite positioning system measurements and/or one or more inertial sensor measurements, and wherein using the first location of the vehicle is further based on having at least a threshold confidence in the first location.

Clause 4. The method according to clause 1, further comprising: performing a Minimum Risk Condition (MRC) maneuver, or alerting a driver of the vehicle, or giving control of the vehicle to the driver of the vehicle, or any combination of two or more thereof, based on the first RSU-based location of the vehicle being outside of an acceptable error margin of the first location.

Clause 5. The method according to clause 1, further comprising: replacing the first location of the vehicle with the first RSU-based location of the vehicle based on the first RSU-based location of the vehicle being outside of an acceptable error margin of the first location.

Clause 6. The method according to clause 5, further comprising: obtaining a second location of the vehicle corresponding to a second time; receiving, at the vehicle from a second RSU, a second RSU signal including an indication of a location of the second RSU; obtaining one or more location measurements between the vehicle and the second RSU based on one or more sensors of the vehicle; determining a second RSU-based location of the vehicle corresponding to the second time based, at least in part, on the one or more location measurements of the vehicle relative the second RSU, and the location of the second RSU; comparing the second location of the vehicle with the second RSU-based location of the vehicle to validate the second location; and either: using the second location of the vehicle based on the second RSU-based location of the vehicle being within an acceptable error margin of the second location, or performing a Minimum Risk Condition (MRC) maneuver, or alerting a driver, or giving control of the vehicle to the driver, or any combination of two or more thereof, based on the second RSU-based location of the vehicle being outside an error of margin of the second location.

Clause 7. The method according to of clause 1, wherein obtaining the first location includes obtaining the first location from a satellite position system of the vehicle, or obtaining the first location based on one or more Inertial Measurement Unit (IMU) sensor measurements, or a combination of two or more thereof.

Clause 8. The method according to clause 1, wherein the first RSU signal further includes an RSU identification number, the method further including: determining whether the RSU identification number is registered in a map; and reporting the RSU identification number to a server based on the RSU identification number being absent from the map.

Clause 9. The method according to clause 1, wherein the one or more sensors includes a LIDAR device, a camera device, a radar device, or any combination of two or more thereof.

Clause 10. The method according to clause 1, wherein obtaining the one or more location measurements of the vehicle relative the first RSU includes using radio localization based on existence of a non-line-of-sight condition between the vehicle and the first RSU.

Clause 11. A system for determining validity of a location of a vehicle, the system comprising: memory; at least one processor communicatively coupled to the memory, and configured to: obtain a first location of the vehicle corresponding to a first time; receive, at the vehicle from a first Roadside Unit (RSU), a first RSU signal including an indication of a location of the first RSU; obtain one or more location measurements of the vehicle relative the first RSU based on one or more sensors of the vehicle; determine a first RSU-based location of the vehicle corresponding to the first time based, at least in part, on the one or more location measurements of the vehicle relative the first RSU, and the location of the first RSU; and compare the first location of the vehicle with the first RSU-based location of the vehicle.

Clause 12. The system according to clause 11, wherein the at least one processor is further configured to use the first location of the vehicle based on the first RSU-based location of the vehicle being within an acceptable error margin of the first location.

Clause 13. The system according to clause 12, wherein the first location is based on one or more satellite positioning system measurements and/or one or more inertial sensor measurements, and wherein the at least one processor is further configured to use the first location of the vehicle based on having at least a threshold confidence level in the first location.

Clause 14. The system according to clause 11, wherein the at least one processor is further configured to: perform a Minimum Risk Condition (MRC) maneuver, or alerting a driver of the vehicle, or giving control of the vehicle to the driver of the vehicle, or any combination of two or more thereof, based on the first RSU-based location of the vehicle being outside of an acceptable error margin of the first location.

Clause 15. The system according to clause 11, wherein the at least one processor is further configured to: replace the first location of the vehicle with the first RSU-based location of the vehicle based on the first RSU-based location of the vehicle being outside of an acceptable error margin of the first location.

Clause 16. The system according to clause 15, wherein the at least one processor is further configured to: obtain a second location of the vehicle corresponding to a second time; receive, at the vehicle from a second RSU, a second RSU signal including an indication of a location of the second RSU; obtain one or more location measurements of the vehicle relative the second RSU based on one or more sensors of the vehicle; determine a second RSU-based location of the vehicle corresponding to the second time based, at least in part, on the one or more location measurements of the vehicle relative the second RSU, and the location of the second RSU; compare the second location of the vehicle with the second RSU-based location of the vehicle to validate the second location; and either: use the second location of the vehicle based on the second RSU-based location of the vehicle being within an acceptable error margin of the second location, or perform a Minimum Risk Condition (MRC) maneuver, or alerting a driver, or giving control of the vehicle to the driver, or any combinations of two or more thereof, based on the second RSU-based location of the vehicle being outside an error of margin of the second location.

Clause 17. The system according to clause 11, wherein the at least one processor is further configured to obtain the first location by obtaining the first location from a satellite position system of the vehicle, or obtaining the first location based on one or more Inertial Measurement Unit (IMU) sensor measurements, or a combination of two or more thereof.

Clause 18. The system according to clause 11, wherein the first RSU signal includes an RSU identification number, and wherein the at least one processor is further configured to: determine whether the RSU identification number is registered in a map; report the RSU identification number to a server based on the RSU identification number being absent from the map.

Clause 19. The system according to clause 11, wherein the one or more sensors includes a LIDAR device, a camera device, a radar device, or any combination of two or more thereof.

Clause 20. The system according to clause 11, wherein the at least one processor configured to obtain the first location by obtaining one or more location measurements of the vehicle relative the first RSU includes using radio localization based on existence of a non-line-of-sight condition between the vehicle and the first RSU.

Clause 21. A system for determining validity of a location of a vehicle, the system comprising: means for obtaining a first location of the vehicle corresponding to a first time; means for receiving, at the vehicle from a first Roadside Unit (RSU), a first RSU signal including an indication of a location of the first RSU; means for obtaining one or more location measurements of the vehicle relative the first RSU based on one or more sensors of the vehicle; means for determining a first RSU-based location of the vehicle corresponding to the first time based, at least in part, on the one or more location measurements of the vehicle relative the first RSU, and the location of the first RSU; and means for comparing the first location of the vehicle with the first RSU-based location of the vehicle.

Clause 22. The system according to clause 21, further comprising: means for using the first location of the vehicle based on the first RSU-based location of the vehicle being within an acceptable error margin of the first location.

Clause 23. The system according to clause 22, wherein the first location is based on one or more satellite positioning system measurements and/or one or more inertial sensor measurements, and wherein the means for using the first location of the vehicle is further based on having at least a threshold confidence in the first location.

Clause 24. The system according to clause 21, further comprising: means for performing a Minimum Risk Condition (MRC) maneuver, or means for alerting a driver of the vehicle, or means for giving control of the vehicle to the driver of the vehicle, or any combination of two or more thereof, based on the first RSU-based location of the vehicle being outside of an acceptable error margin of the first location.

Clause 25. The system according to clause 21, further comprising: means for replacing the first location of the vehicle with the first RSU-based location of the vehicle based on the first RSU-based location of the vehicle being outside an acceptable error margin of the first location.

Clause 26. The system according to clause 25, further comprising: means for obtaining a second location of the vehicle corresponding to a second time; means for receiving, at the vehicle from a second RSU, a second RSU signal including an indication of a location of the second RSU; means for obtaining one or more location measurements of the vehicle relative the second RSU based on one or more sensors of the vehicle; means for determining a second RSU-based location of the vehicle corresponding to the second time based, at least in part, on the one or more location measurements of the vehicle relative the second RSU, and the location of the second RSU; means for comparing the second location of the vehicle with the second RSU-based location of the vehicle to validate the second location; and either: means for using the second location of the vehicle based on the second RSU-based location of the vehicle being within an acceptable error margin of the second location, or means for performing a Minimum Risk Condition (MRC) maneuver, or alerting a driver, or giving control of the vehicle to the driver or any combination of two or more thereof, based on the second RSU-based location of the vehicle being outside an acceptable error margin of the second location.

Clause 27. The system according to of clause 21, wherein the means for obtaining the first location includes a satellite position system of the vehicle, or one or more Inertial Measurement Unit (IMU) sensor measurements, or a combination of two or more thereof.

Clause 28. The system according to clause 21, wherein the first RSU signal further includes an RSU identification number, the system further including: means for determining whether the RSU identification number is registered in a map; means for reporting the RSU identification number to a server based on the RSU identification number being absent from the map.

Clause 29. The system according to clause 29, wherein the one or more sensors includes a LIDAR device, a camera device, a radar device, or any combination of two or more thereof.

Clause 30. The system according to clause 21, wherein the means for obtaining the one or more location measurements of the vehicle relative the first RSU includes means or using radio localization based on existence of a non-line-of-sight condition between the vehicle and the first RSU.

Clause 31. A non-transitory processor-readable storage medium comprising processor-readable instructions configured to cause one or more processors to determine validity of a location of a vehicle, comprising: code for obtaining a first location of the vehicle corresponding to a first time; code for receiving, at the vehicle from a first Roadside Unit (RSU), a first RSU signal including an indication of a location of the first RSU; code for obtaining one or more location measurements of the vehicle relative the first RSU based on one or more sensors of the vehicle; code for determining a first RSU-based location of the vehicle corresponding to the first time based, at least in part, on the one or more location measurements of the vehicle relative the first RSU, and the location of the first RSU; and code for comparing the first location of the vehicle with the first RSU-based location of the vehicle.

Clause 32. The non-transitory processor-readable storage medium according to clause 31, further comprising: code for using the first location of the vehicle based on the first RSU-based location of the vehicle being within an acceptable error margin of the first location.

Clause 33. The non-transitory processor-readable storage medium according to clause 32, wherein the first location is based on one or more satellite positioning system measurements and/or one or more inertial sensor measurements, and wherein the program code for using the first location of the vehicle is further based on having at least a threshold confidence in the first location.

Clause 34. The non-transitory processor-readable storage medium according to clause 31, further comprising: code for performing a Minimum Risk Condition (MRC) maneuver, or alerting a driver of the vehicle, or giving control of the vehicle to the driver of the vehicle, or any combination of two or more thereof, based on the first RSU-based location of the vehicle being outside an acceptable error margin of the first location.

Clause 35. The non-transitory processor-readable storage medium according to clause 31, further comprising: code for replacing the first location of the vehicle with the first RSU-based location of the vehicle based on the first RSU-based location of the vehicle being outside an acceptable error margin of the first location.

Clause 36. The non-transitory processor-readable storage medium according to clause 35, further comprising: code for obtaining a second location of the vehicle corresponding to a second time; code for receiving, at the vehicle from a second RSU, a second RSU signal including an indication of a location of the second RSU; code for obtaining one or more location measurements of the vehicle relative the second RSU based on one or more sensors of the vehicle; code for determining a second RSU-based location of the vehicle corresponding to the second time based, at least in part, on the one or more location measurements of the vehicle relative the second RSU, and the location of the second RSU; code for comparing the second location of the vehicle with the second RSU-based location of the vehicle to validate the second location; and either: code for using the second location of the vehicle based on the second RSU-based location of the vehicle being within an acceptable error margin of the second location, or code for performing a Minimum Risk Condition (MRC) maneuver, alerting a driver, giving control of the vehicle to the driver or combinations thereof, based on the second RSU-based location of the vehicle being outside an error or margin of the second location.

Clause 37. The non-transitory processor-readable storage medium according to clause 31, wherein the code for obtaining the first location includes code for obtaining the first location from a satellite position system of the vehicle, or code for obtaining the first location based on one or more Inertial Measurement Unit (IMU) sensor measurements, or a combination of two or more thereof.

Clause 38. The non-transitory processor-readable storage medium according to clause 31, wherein the first RSU signal further includes an RSU identification number, the storage medium further including: code for determining whether the RSU identification number is registered in a map; code for reporting the RSU identification number to a server based on the RSU identification number being absent from the map.

Clause 39. The non-transitory processor-readable storage medium according to clause 31, wherein the one or more sensors includes a LIDAR device, or a camera device, or a radar device, or any combination of two or more thereof.

Clause 40. The non-transitory processor-readable storage medium according to clause 31, wherein the code for obtaining the one or more location measurements of the vehicle relative to the first RSU includes code using radio localization based on existence of a non-line-of-sight condition between the vehicle and the first RSU.

What is claimed is:

1. A method of determining validity of a location of a vehicle, the method comprising:
obtaining a first location of the vehicle corresponding to a first time;
receiving, at the vehicle from a first Roadside Unit (RSU), a first RSU signal including an indication of a location of the first RSU;
obtaining one or more location measurements of the vehicle relative the first RSU based on one or more sensors of the vehicle;
determining a first RSU-based location of the vehicle corresponding to the first time based, at least in part, on the one or more location measurements of the vehicle relative the first RSU, and the location of the first RSU; and
comparing the first location of the vehicle with the first RSU-based location of the vehicle.

2. The method according to claim 1, further comprising:
using the first location of the vehicle based on the first RSU-based location of the vehicle being within an acceptable error margin of the first location.

3. The method according to claim 2, wherein the first location is based on one or more satellite positioning system measurements and/or one or more inertial sensor measurements, and wherein using the first location of the vehicle is further based on having at least a threshold confidence in the first location.

4. The method according to claim 1, further comprising:
performing a Minimum Risk Condition (MRC) maneuver, or alerting a driver of the vehicle, or giving control of the vehicle to the driver of the vehicle, or any combination of two or more thereof, based on the first RSU-based location of the vehicle being outside of an acceptable error margin of the first location.

5. The method according to claim 1, further comprising:
replacing the first location of the vehicle with the first RSU-based location of the vehicle based on the first RSU-based location of the vehicle being outside of an acceptable error margin of the first location.

6. The method according to claim 5, further comprising:
obtaining a second location of the vehicle corresponding to a second time;
receiving, at the vehicle from a second RSU, a second RSU signal including an indication of a location of the second RSU;
obtaining one or more location measurements between the vehicle and the second RSU based on one or more sensors of the vehicle;
determining a second RSU-based location of the vehicle corresponding to the second time based, at least in part, on the one or more location measurements of the vehicle relative the second RSU, and the location of the second RSU;
comparing the second location of the vehicle with the second RSU-based location of the vehicle to validate the second location; and
either:
using the second location of the vehicle based on the second RSU-based location of the vehicle being within an acceptable error margin of the second location, or
performing a Minimum Risk Condition (MRC) maneuver, or alerting a driver, or giving control of the vehicle to the driver, or any combination of two or more thereof, based on the second RSU-based location of the vehicle being outside an error of margin of the second location.

7. The method according to of claim 1, wherein obtaining the first location includes obtaining the first location from a satellite position system of the vehicle, or obtaining the first location based on one or more Inertial Measurement Unit (IMU) sensor measurements, or a combination of two or more thereof.

8. The method according to claim 1, wherein the first RSU signal further includes an RSU identification number, the method further including:
determining whether the RSU identification number is registered in a map; and
reporting the RSU identification number to a server based on the RSU identification number being absent from the map.

9. The method according to claim 1, wherein the one or more sensors includes a LIDAR device, a camera device, a radar device, or any combination of two or more thereof.

10. The method according to claim 1, wherein obtaining the one or more location measurements of the vehicle relative the first RSU includes using radio localization based on existence of a non-line-of-sight condition between the vehicle and the first RSU.

11. A system for determining validity of a location of a vehicle, the system comprising:
memory;
at least one processor communicatively coupled to the memory, and configured to:
obtain a first location of the vehicle corresponding to a first time;
receive, at the vehicle from a first Roadside Unit (RSU), a first RSU signal including an indication of a location of the first RSU;
obtain one or more location measurements of the vehicle relative the first RSU based on one or more sensors of the vehicle;
determine a first RSU-based location of the vehicle corresponding to the first time based, at least in part, on the one or more location measurements of the vehicle relative the first RSU, and the location of the first RSU; and
compare the first location of the vehicle with the first RSU-based location of the vehicle.

12. The system according to claim 11, wherein the at least one processor is further configured to use the first location of the vehicle based on the first RSU-based location of the vehicle being within an acceptable error margin of the first location.

13. The system according to claim 12, wherein the first location is based on one or more satellite positioning system measurements and/or one or more inertial sensor measurements, and wherein the at least one processor is further configured to use the first location of the vehicle based on having at least a threshold confidence level in the first location.

14. The system according to claim 11, wherein the at least one processor is further configured to:
perform a Minimum Risk Condition (MRC) maneuver, or alerting a driver of the vehicle, or giving control of the vehicle to the driver of the vehicle, or any combination of two or more thereof, based on the first RSU-based location of the vehicle being outside of an acceptable error margin of the first location.

15. The system according to claim 11, wherein the at least one processor is further configured to:
replace the first location of the vehicle with the first RSU-based location of the vehicle based on the first RSU-based location of the vehicle being outside of an acceptable error margin of the first location.

16. The system according to claim 15, wherein the at least one processor is further configured to:
obtain a second location of the vehicle corresponding to a second time;
receive, at the vehicle from a second RSU, a second RSU signal including an indication of a location of the second RSU;
obtain one or more location measurements of the vehicle relative the second RSU based on one or more sensors of the vehicle;
determine a second RSU-based location of the vehicle corresponding to the second time based, at least in part, on the one or more location measurements of the vehicle relative the second RSU, and the location of the second RSU;
compare the second location of the vehicle with the second RSU-based location of the vehicle to validate the second location; and
either:
use the second location of the vehicle based on the second RSU-based location of the vehicle being within an acceptable error margin of the second location, or
perform a Minimum Risk Condition (MRC) maneuver, or alerting a driver, or giving control of the vehicle to the driver, or any combinations of two or more thereof, based on the second RSU-based location of the vehicle being outside an error of margin of the second location.

17. The system according to claim 11, wherein the at least one processor is further configured to obtain the first location by obtaining the first location from a satellite position system of the vehicle, or obtaining the first location based on one or more Inertial Measurement Unit (IMU) sensor measurements, or a combination of two or more thereof.

18. The system according to claim 11, wherein the first RSU signal includes an RSU identification number, and wherein the at least one processor is further configured to:
determine whether the RSU identification number is registered in a map;
report the RSU identification number to a server based on the RSU identification number being absent from the map.

19. The system according to claim 11, wherein the one or more sensors includes a LIDAR device, a camera device, a radar device, or any combination of two or more thereof.

20. The system according to claim 11, wherein the at least one processor configured to obtain the first location by obtaining one or more location measurements of the vehicle relative the first RSU includes using radio localization based on existence of a non-line-of-sight condition between the vehicle and the first RSU.

21. A system for determining validity of a location of a vehicle, the system comprising:
means for obtaining a first location of the vehicle corresponding to a first time;
means for receiving, at the vehicle from a first Roadside Unit (RSU), a first RSU signal including an indication of a location of the first RSU;
means for obtaining one or more location measurements of the vehicle relative the first RSU based on one or more sensors of the vehicle;
means for determining a first RSU-based location of the vehicle corresponding to the first time based, at least in part, on the one or more location measurements of the vehicle relative the first RSU, and the location of the first RSU; and
means for comparing the first location of the vehicle with the first RSU-based location of the vehicle.

22. The system according to claim 21, further comprising:
means for using the first location of the vehicle based on the first RSU-based location of the vehicle being within an acceptable error margin of the first location.

23. The system according to claim 22, wherein the first location is based on one or more satellite positioning system measurements and/or one or more inertial sensor measurements, and wherein the means for using the first location of the vehicle is further based on having at least a threshold confidence in the first location.

24. The system according to claim 21, further comprising:
means for performing a Minimum Risk Condition (MRC) maneuver, or means for alerting a driver of the vehicle, or means for giving control of the vehicle to the driver of the vehicle, or any combination of two or more thereof, based on the first RSU-based location of the vehicle being outside of an acceptable error margin of the first location.

25. The system according to claim 21, further comprising:
means for replacing the first location of the vehicle with the first RSU-based location of the vehicle based on the first RSU-based location of the vehicle being outside an acceptable error margin of the first location.

26. The system according to claim 25, further comprising:
means for obtaining a second location of the vehicle corresponding to a second time;
means for receiving, at the vehicle from a second RSU, a second RSU signal including an indication of a location of the second RSU;
means for obtaining one or more location measurements of the vehicle relative the second RSU based on one or more sensors of the vehicle;
means for determining a second RSU-based location of the vehicle corresponding to the second time based, at least in part, on the one or more location measurements of the vehicle relative the second RSU, and the location of the second RSU;
means for comparing the second location of the vehicle with the second RSU-based location of the vehicle to validate the second location; and
either:
means for using the second location of the vehicle based on the second RSU-based location of the vehicle being within an acceptable error margin of the second location, or
means for performing a Minimum Risk Condition (MRC) maneuver, or alerting a driver, or giving control of the vehicle to the driver or any combination of two or more thereof, based on the second RSU-based location of the vehicle being outside an acceptable error margin of the second location.

27. The system according to of claim 21, wherein the means for obtaining the first location includes a satellite position system of the vehicle, or one or more Inertial Measurement Unit (IMU) sensor measurements, or a combination of two or more thereof.

28. The system according to claim 21, wherein the first RSU signal further includes an RSU identification number, the system further including:
means for determining whether the RSU identification number is registered in a map;
means for reporting the RSU identification number to a server based on the RSU identification number being absent from the map.

29. The system according to claim 21, wherein the one or more sensors includes a LIDAR device, a camera device, a radar device, or any combination of two or more thereof.

30. A non-transitory processor-readable storage medium comprising processor-readable instructions configured to cause one or more processors to determine validity of a location of a vehicle, comprising:
code for obtaining a first location of the vehicle corresponding to a first time;
code for receiving, at the vehicle from a first Roadside Unit (RSU), a first RSU signal including an indication of a location of the first RSU;
code for obtaining one or more location measurements of the vehicle relative the first RSU based on one or more sensors of the vehicle;
code for determining a first RSU-based location of the vehicle corresponding to the first time based, at least in part, on the one or more location measurements of the vehicle relative the first RSU, and the location of the first RSU; and
code for comparing the first location of the vehicle with the first RSU-based location of the vehicle.
